(19) United States
(12) Patent Application Publication
(10) Pub. No.: US 2008/0100030 A1
(43) Pub. Date: May 1, 2008

(54) EZ-Up Ride Off Vertical Motorcycle Center Stand

(75) Inventors: Rod Brakhage, Stillwater, OK (US); Al J. Meyers, Grand Rapids, MN (US)

Correspondence Address: MARTIN S. HIGH, P.O. BOX 217, STILLWATER, OK, 74076, US

(73) Assignee: WHEELDOCK, LLC, Stillwater, OK (US)

(21) Appl. No.: 11/925,737

(22) Filed: Oct. 26, 2007

Related U.S. Application Data
(60) Provisional application No. 60/863,567, filed on Oct. 30, 2006.

(51) Int. Cl. B62H 1/04

(52) U.S. Cl. 280/293

(57) ABSTRACT

An embodiment of the EZ-Up Ride Off Vertical Motorcycle Center Stand is comprised of a frame bracket assembly and a H-bracket assembly. To operate the embodiment, the user pushes downward on the lever while still on the motorcycle and the stand rotates underneath the motorcycle and imposes a force upward on the rear end of the motorcycle sufficient to hold the motorcycle up in the vertical position. This motion transfers enough weight to the center stand to stabilize the motorcycle without the motorcycle tipping over. Because this is accomplished with the rear wheel still on the ground there is sufficient traction for the motorcycle to drive off of the center stand with one or two passengers by utilizing the power of the motor. Also by locking the stand in the parked, upright position, theft is much more difficult as the bike cannot be simply rolled away.

### CROSS-REFERENCE TO RELATED APPLICATIONS

This application claims priority of the provisional application with Ser. No. 60/863,567 with the title “EZ-up Ride Off Vertical Motorcycle Center Stand” on Oct. 30, 2006. The entire contents of provisional application 60/863,567 are herein incorporated by reference.

### STATEMENT REGARDING FEDERALLY SPONSORED RESEARCH OR DEVELOPMENT

Not applicable.

### FIELD OF THE EMBODIMENTS

The field of the embodiments described below broadly is motorcycle center stands.

### BACKGROUND OF THE EMBODIMENTS

The prior art can generally be described as a U-shaped or H-shaped structure, which is normally held in a horizontal position by means of a spring beneath the motorcycle when not in use. This structure is used for holding the bike upright in a vertical position for parking, storage, or for cleaning and is engaged by first placing the motorcycle on the side stand then stepping off to the side of the motorcycle. After dismounting the motorcycle when using the prior art motorcycle stands, the user must then execute a difficult combination of steps to engage the prior art motorcycle stands. The user must press down on the motorcycle stand foot lever while simultaneously manually lifting the motorcycle up onto the stand, which raises the back wheel of the motorcycle clear of the ground. This combination of actions generally requires a great deal of coordination and strength. A large number of motorcycles, especially motorcycles manufactured by Harley-Davidson, are particularly heavy and require an extreme amount of force to raise the rear wheel free of the ground. In some cases, it is impossible for a user to lift the rear wheel sufficiently to engage a prior art center mounted motorcycle stand. The prior art stand also places the rear wheel off the ground making driving off the stand impossible.

Getting off the motorcycle first is a significant disadvantage as it would be preferable to engage the motorcycle stand while still seated on the motorcycle. This would allow the motorcycle to be pulled into the garage close to a wall or any other tight space for parking or storage, and the operator would then be able to get off on either side leaving the motorcycle standing upright with very little gap between it and the wall or other obstruction. This would save significant space. It would also be much easier to balance the motorcycle while on it. Unfortunately, these features are not possible with the motorcycle stands taught by the prior art.

The prior art teaches a variety of locking means for a motorcycle stand, but no prior art teaches a simple method. In some prior art references, a key-cylinder is used which is susceptible to dirt and grime, fouling the locking mechanism. A simple means of locking the stand to prevent motorcycle theft is required.

Lastly, the prior art teaches center mounted motorcycle stands that must be disengaged in essentially the reverse order that is used to engage the stand. The user must first push the motorcycle forward causing the bike to go up and over the highest arc of the stand, which then lowers the bike off of the stand and places the rear wheel back in contact with the ground. The U-shaped or H-shaped structure utilizes springs to return to the horizontal position for travel. This motion requires a great deal of force while on the bike, and when done from the side of the bike, it is common for the bike to fall away from the operator resulting in damage to the motorcycle. Only after removing the bike from the center stand may the user and the passenger mount the motorcycle and begin the ride. This procedure is as difficult both physically and logistically as placing the motorcycle up on the motorcycle stand.

In summary, the prior art teaches motorcycle center stands that require dismounting of the motorcycle and a combination of engaging the motorcycle center stand with the foot and lifting the rear end of the motorcycle. The procedure must be reversed to begin riding the motorcycle. The prior art does not teach a simplistic manner of locking the center stand in the upright position for security purposes.

The embodiments below describe a center-mounted motorcycle stand that is easier to engage, particularly with heavier motorcycles; does not require the user to dismount the motorcycle first to engage the stand; and allows the user to simply ride off from the parked condition to disengage the stand. Additionally, this stand allows for a passenger to get on the motorcycle while it is parked on the stand without requiring the operator to balance or hold up the motorcycle. The drive-off feature is not affected by having two people on the motorcycle. Further, the embodiments teach a simplistic means to lock the stand. The embodiments are designed to overcome the coordinated, and difficult movement of pushing down with the foot while lifting the bike enough to raise the wheel free of the ground. The embodiments of the EZ-Up Ride Off Vertical Motorcycle Center Stand solve the common problems encountered with the inventions in the prior art.

### SUMMARY OF THE EMBODIMENTS

The embodiments of the EZ-Up Ride Off Vertical Motorcycle Center Stand 100 are comprised of a frame bracket assembly 120 and a H-bracket assembly 130. The frame bracket assembly 120 and the H-bracket assembly 130 are connected via a common axel 110 that is inserted through bushings on the frame bracket assembly 120 and H-bracket assembly 130. A spring engagement means normally keeps the H-bracket assembly in the horizontal position while the motorcycle is in use. The horizontal position is accomplished when the H-bracket assembly 130 is horizontal and extends towards the rear of the motorcycle. In the horizontal position, the rear wheel of the motorcycle is located between the vertical supports 104 of the H-bracket assembly 130. The frame bracket assembly 120 is comprised of a motorcycle frame bracket 109, a plurality of threaded square washers 107, and a plurality of bolts 108. The H-bracket assembly 130 is comprised of a pair of feet 106, a pair of vertical supports 104, a horizontal support 102, two H-bracket bushings 111, and a foot lever 101. The frame bracket assembly 120 is comprised of a pair of frame shoes 108 a frame horizontal support, and frame bracket assembly bushings 113. The various embodiments are assembled onto the motorcycle via bolts 108 that are inserted through holes formed by the bracket assembly 120, up through existing holes in the frame of the motorcycle and through square nuts 107 on top of the motorcycle frame (see FIGS. 4, 5, 6, 7, 10, 11). The axel is held in place via a resistance fit from the H-bracket bushings 111 and the frame bracket assembly bushings 113 and through the use of an anaerobic adhesive to hold the axel in place. To operate the embodiments, the user stops the motorcycle at the appropriate place. The user then places his foot on lever 101. The user pushes downward on lever 101 and the stand rotates underneath the motorcycle. Both leverage and cam action imposes an upward force on the rear end of the motorcycle when the center stand is pressed down. The embodiments can be locked by placing a padlock 105 through the aperture 701 formed by the frame bracket assembly.

In this respect, before explaining at least one embodiment in detail, it is to be understood that the embodiments are not limited in this application to the details of construction and to the arrangements of the components set forth in the following description or illustrated in the drawings. The embodiments are capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present embodiments. Additional benefits and advantages of the present embodiments will become apparent in those skilled in the art to which the present embodiments relates from the subsequent description of the preferred embodiment and the appended claims, taken in conjunction with the accompanying drawings. It is important, therefore, that the claims be regarded as including such equivalent constructions insofar as they do not depart from the spirit and scope of the embodiments.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments described in the application which is measured by the claims, nor is it intended to be limiting as to the scope of the embodiments in any way.

### BRIEF DESCRIPTION OF THE DRAWINGS

FIG. 1 is a perspective view of the embodiments in the extended position showing a padlock engaged, as one would see an embodiment looking from the rear of the motorcycle.

FIG. 2 is a perspective view of an embodiment showing a padlock not engaged, as one would see an embodiment looking from the rear of the motorcycle.

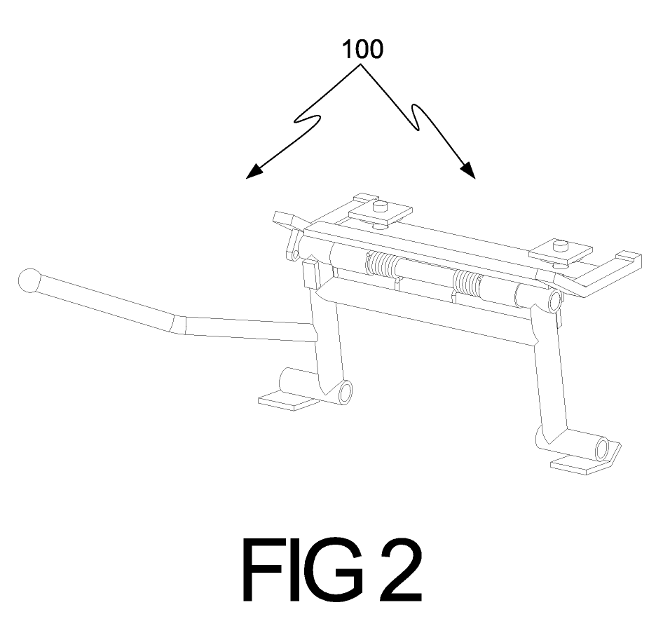

FIG. 3 is an exploded view of an embodiment shown in the extended position, as one would see an embodiment looking from the rear of the motorcycle.

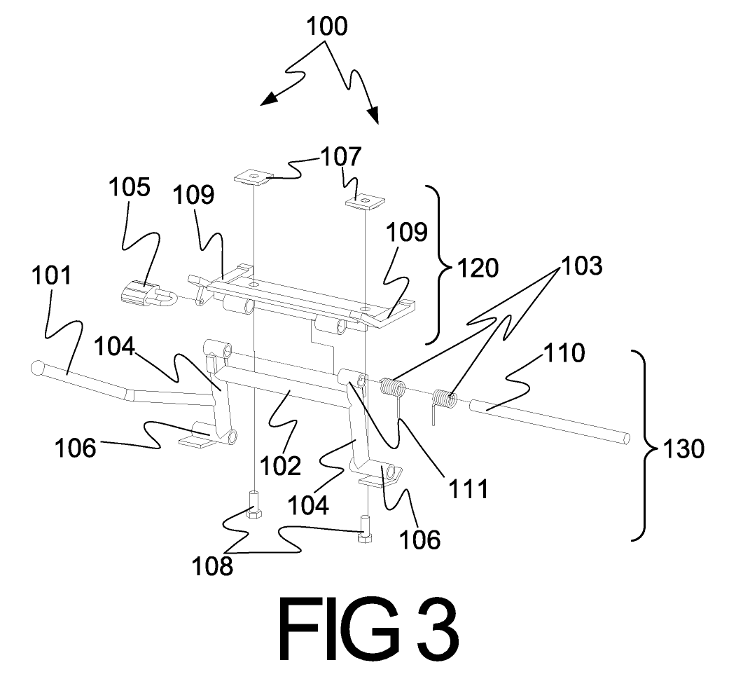

FIG. 4 shows a perspective view of an embodiment affixed to the frame of a motorcycle and in the upright position as one would see an embodiment looking from the rear of the motorcycle and above.

FIG. 5 is another perspective view of an embodiment engaged with the motorcycle frame as shown from below the motorcycle as one would see an embodiment looking from the front of the motorcycle and below.

FIG. 6 is yet another perspective view of an embodiment in the extended position with a padlock engaged as one would see the embodiment looking from the rear of the motorcycle and above.

FIG. 7 is a perspective view of an embodiment in the extended position showing no padlock, as one would see an embodiment looking from the rear of the motorcycle and above.

FIG. 8 is a perspective view of an embodiment showing a top view of an embodiment in the up position as one would see an embodiment looking from the rear of the motorcycle and above.

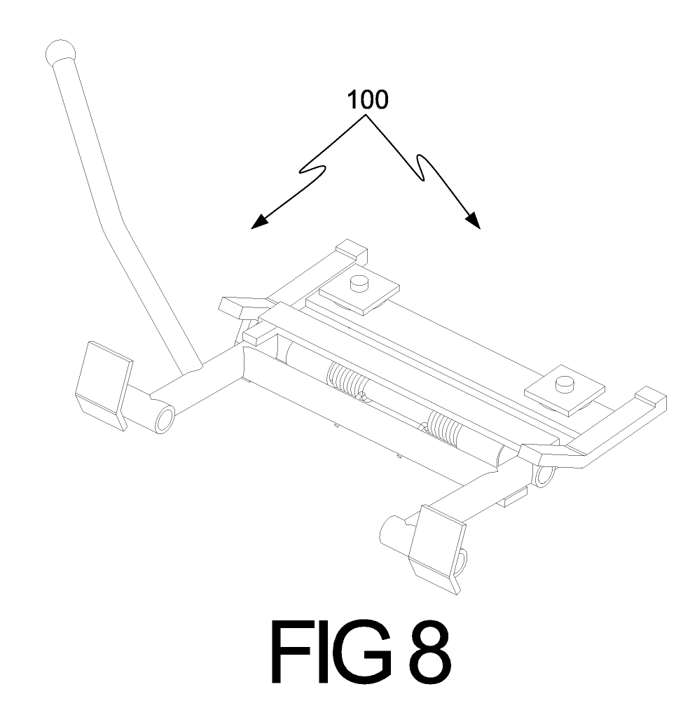

FIG. 9 is an exploded view diagram of an embodiment showing how the axel engages through both the H-bracket assembly and frame bracket assembly, as one would see the embodiment looking from the rear of the motorcycle and above.

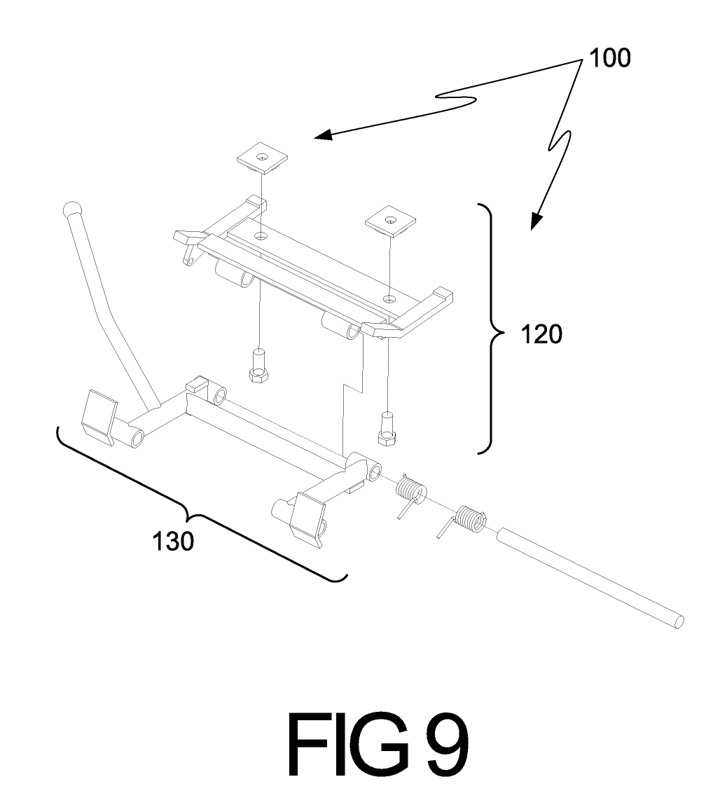

FIG. 10 is an exploded view of an embodiment showing how the axel engages in both the frame bracket assembly and the H-bracket assembly and how an embodiment is affixed to the frame of a motorcycle, as one would see the embodiment looking from the rear of the motorcycle and above.

FIG. 11 is another perspective exploded view of an embodiment showing how the axel engages the frame bracket assembly and the H-bracket assembly and also showing how the embodiment is affixed to the frame of a motorcycle as one would see the embodiment looking from the rear of the motorcycle and above.

FIG. 12 is an exploded view of an embodiment showing how the axel engages both the frame bracket assembly and the H-bracket assembly, as one would see the embodiment looking from the rear of the motorcycle.

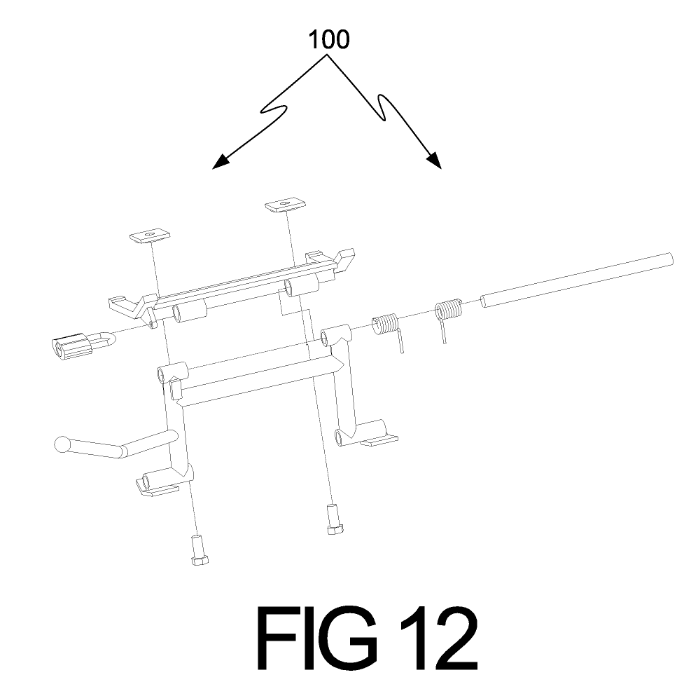

FIG. 13 is a perspective view of an embodiment showing the stand in the extended position with a padlock engaged, as one would see the embodiment looking from the rear of the motorcycle and above.

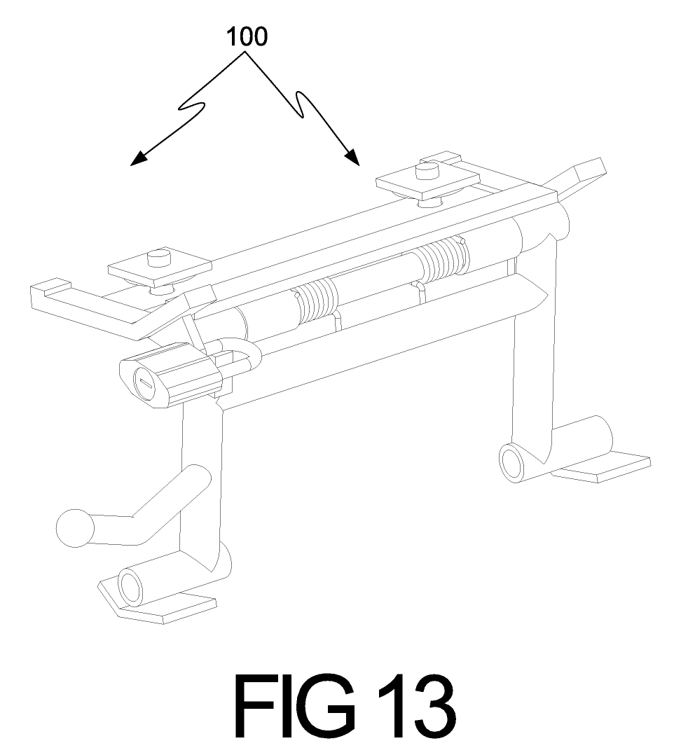

FIG. 14 is a perspective view of an embodiment showing how the embodiment assembles onto the frame of a motorcycle with the motorcycle frame absent showing how the bolts engage to the square washers as one would see the invention looking from the rear of the motorcycle and above.

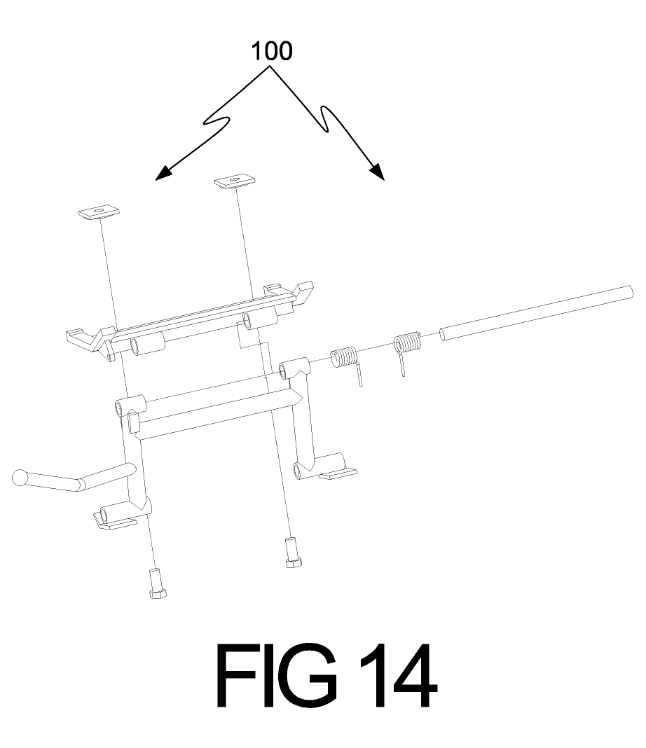

### DETAILED DESCRIPTION OF THE PREFERRED EMBODIMENTS

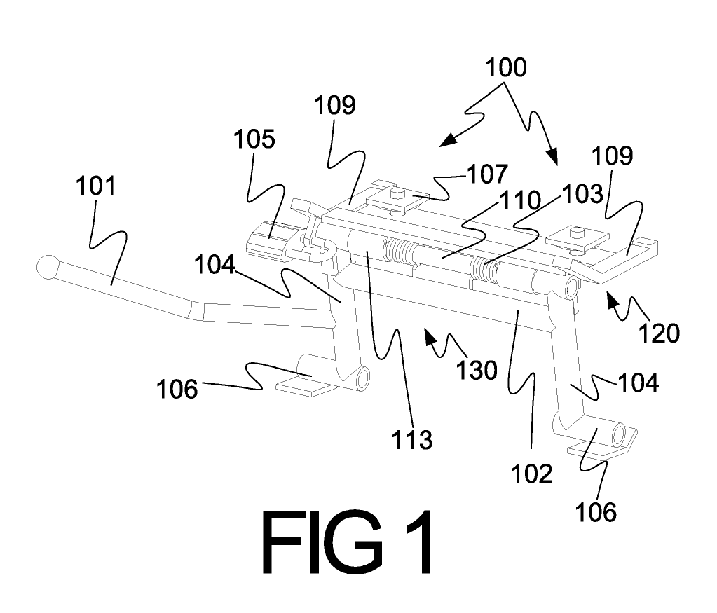

An embodiment of the EZ-Up Ride Off Vertical Motorcycle Center Stand 100 shown in FIG. 1 is comprised of a frame bracket assembly 120 and a H-bracket assembly 130. The frame bracket assembly 120 and the H-bracket assembly 130 are connected via a common axel 110 that is inserted through bushings on the frame bracket assembly 120 and H-bracket assembly 130. A spring engagement means normally keeps the H-bracket assembly in the horizontal position while the motorcycle is being driven. The horizontal position is accomplished when the H-bracket assembly 130 extends towards the rear of the motorcycle. In the horizontal position, the rear wheel of the motorcycle is located between the vertical supports 104 of the H-bracket assembly 130. The frame bracket assembly 120 is comprised of a motorcycle frame bracket 109, a plurality of threaded square washers 107, and a plurality of bolts 108.

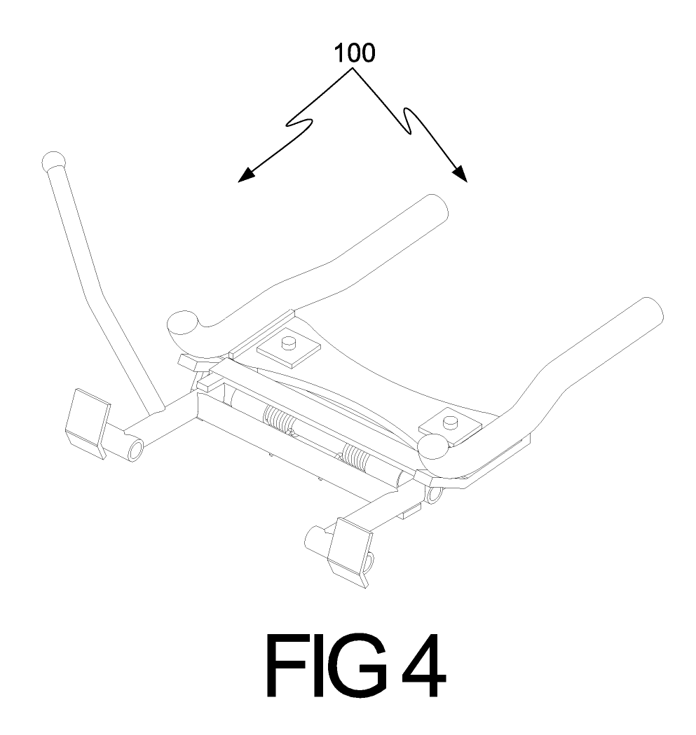

The H-bracket assembly 130 is comprised of a pair of feet 106, a pair of vertical supports 104, a horizontal support 102, two H-bracket bushings 111, and a foot lever 101. The components of the H-bracket assembly arranged to form an essentially H shaped structure that supports the weight of the motorcycle when an embodiment is in the vertical position for parking the motorcycle. When an embodiment is in the horizontal or riding position the H-bracket assembly folds upward against the frame of the motorcycle. The frame bracket assembly and the H-bracket 130 assembly are connected via a common axel that is inserted through bushings on the frame bracket assembly and H-bracket assembly. The H-bracket assembly 130 is engaged to the frame bracket assembly through a means of an axel, which is inserted through both the H-bracket bushings 111 on the H-bracket assembly 130 and through the two frame bracket assembly bushings 113 affixed to the frame bracket assembly. The springs 103 hold the H-bracket assembly in the normally horizontal or riding position. The springs 103 are spiral, cylindrical torsion springs and the springs 103 keep the stand in the normally upright position or horizontal position as shown in FIG. 4.

The frame bracket assembly 120 is comprised of a pair of frame shoes 108 a frame horizontal support, and frame bracket assembly bushings 113. The frame bracket assembly 120 is engaged with the H-bracket assembly 130 via the axel 110. The springs 103 are interposed between the frame bracket assembly bushings 113 as the axel 110 is inserted through the frame bracket assembly bushings 113 and the H-bracket assembly bushings 113. The frame bracket assembly 120 is comprised of a lock aperture 701 formed by bracket assembly 120.

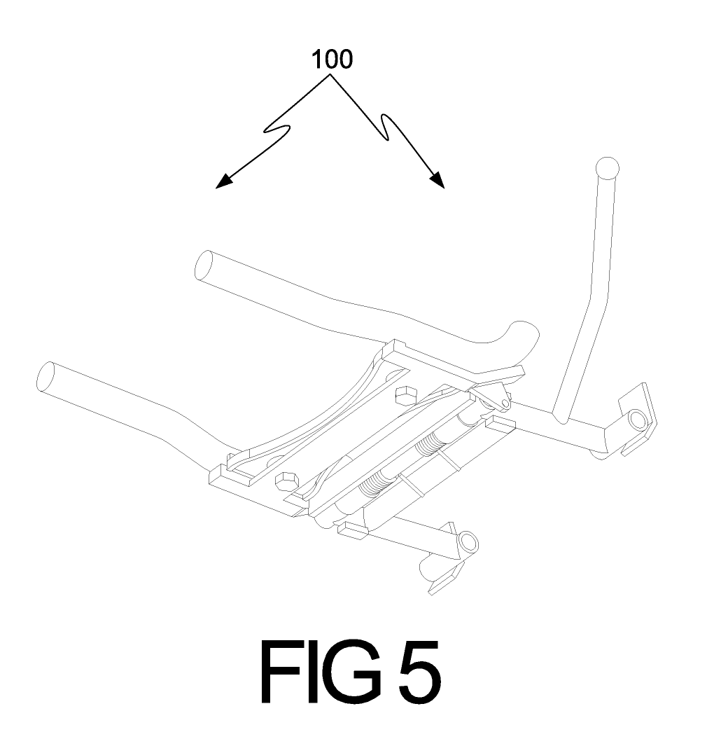

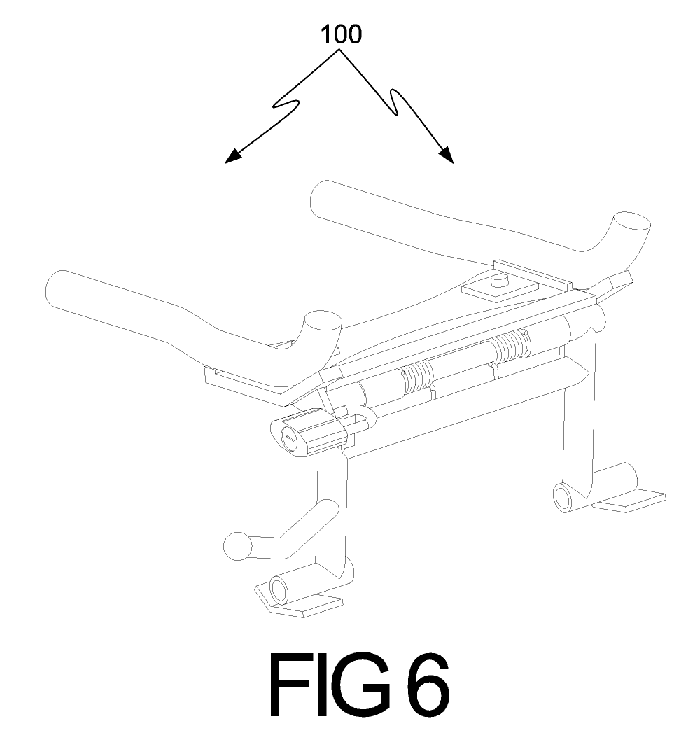

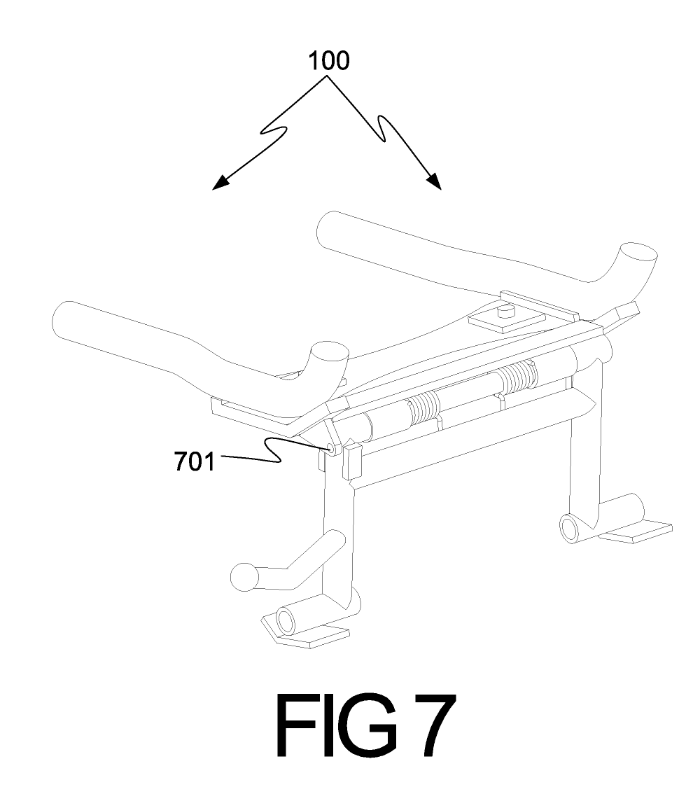

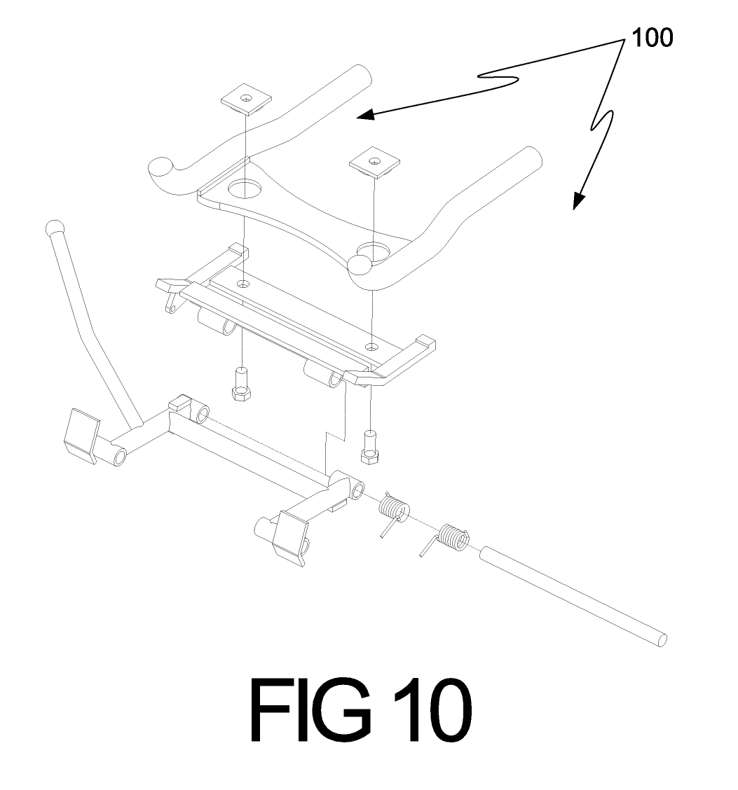

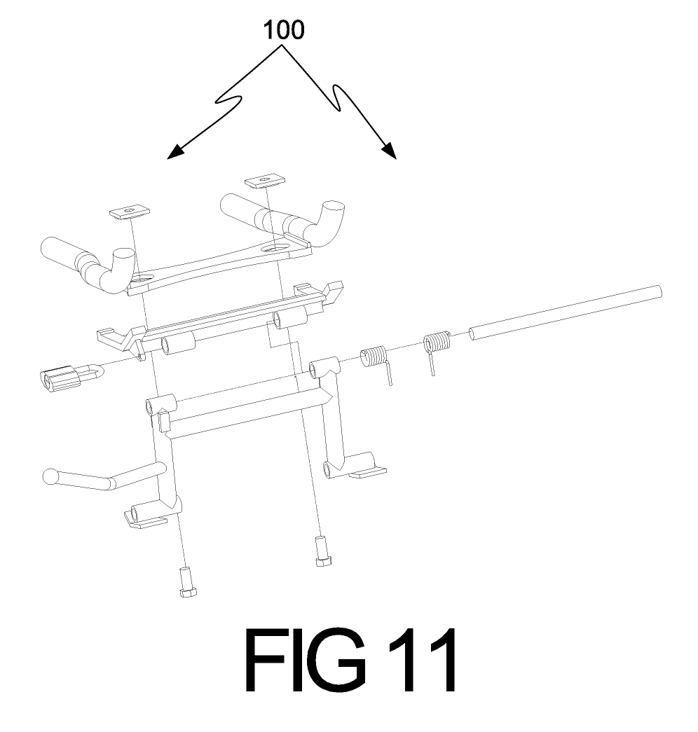

An embodiment is assembled onto the motorcycle via bolts 108 that are inserted through holes formed by the bracket assembly 120, up through the frame of the motorcycle and through square nuts 107 on top of the motorcycle frame (see FIGS. 4, 5, 6, 7, 10, 11). The embodiment is then secured onto the motorcycle via the tightening of the bolts 108.

The axel is held in place via a resistance fit from the H-bracket bushings 111 and the frame bracket assembly bushings 113 and through the use of an anaerobic adhesive to hold the axel in place. As there are minimal longitudinal forces exerted on the embodiment and the common axel 111 no additional means of holding the axel in place is required.

An embodiment is assembled onto the motorcycle via bolts 108 that are inserted through holes formed by the bracket assembly 120, up through holes which are provided in the frame of the motorcycle and through square nuts 107 on top of the motorcycle frame (see FIGS. 4, 5, 6, 7, 10, 11). The embodiment is then secured onto the motorcycle via the tightening of the bolts 108.

One best mode of operation of an embodiment is as follows. To operate the embodiment, the user stops the motorcycle at the appropriate place. The user then places his foot on lever 101. The user pushes downward on lever 101 and the stand rotates underneath the motorcycle. Leverage and cam action provide sufficient force upward on the rear end of the motorcycle to rotate the stand through an arc and approximately fifteen degrees past the vertical center the stand. Since the length of the vertical supports 104 is closely matched to the model of motorcycle for which the stand is purchased for, the user simply has to exert enough force on the foot lever 101 to raise the rear suspension of the motorcycle slightly. The user is not required to raise the rear tire of the motorcycle off of the ground. In short, to operate the embodiment, the user pushes downward on the lever while still on the motorcycle and the stand rotates underneath the motorcycle and imposes a force upward on the rear end of the motorcycle sufficient to hold the motorcycle up in the vertical position.

In operating the embodiments, the user pushes downward on the lever while still on the motorcycle and the stand rotates underneath the motorcycle and imposes a force upward on the rear end of the motorcycle sufficient to hold the motorcycle up in the vertical position. This motion transfers enough weight to the center stand to stabilize the motorcycle for parking, storage, maintenance, cleaning, or for the rider and or passenger to mount without the motorcycle tipping over. Because this is accomplished with the rear wheel still on the ground there is sufficient traction for the motorcycle to drive off of the center stand with one or two passengers by utilizing the power of the motor. Also by locking the stand in the parked, upright position, theft is much more difficult as the bike cannot be simply rolled away.

An embodiment can be locked by placing a padlock 105 through the aperture 701 formed by the frame bracket assembly. This simple means of locking an embodiment prevents an unauthorized user from riding the motorcycle while preventing dirt or grime from building up in the locking mechanism.

In another best mode of operation, to disengage an embodiment, the user simply mounts the motorcycle, places the motorcycle in gear, and rides off. An embodiment simply folds underneath the frame of the motorcycle automatically. Driving off can also be done with a passenger on the motorcycle.

What is claimed is:

1. A motorcycle stand comprised of a means to engage the motorcycle stand while the user is sitting on the motorcycle;
a means to slightly raise the rear suspension of the motorcycle when the motorcycle stand is engaged with the ground;
a means to lock the motorcycle stand in a vertical or parking position to prevent theft of the motorcycle; and
a means to disengaged the motorcycle from the parking or vertical position and place the motorcycle stand in a horizontal or riding position by driving away on the motorcycle.

2. A motorcycle stand as described in claim 1
wherein the means to slightly raise the rear suspension of the motorcycle when the motorcycle stand is engaged with the ground is comprised of
a frame bracket assembly;
an H-bracket assembly wherein the frame bracket assembly and the H-bracket assembly are connected via a common axel that is inserted through bushings on the frame bracket assembly where the H-bracket assembly is in a horizontal position while the motorcycle is being driven and a vertical position while the motorcycle is parked;
wherein the H-bracket assembly is comprised of horizontal and vertical supports wherein the lengths of the vertical and horizontal supports are closely to the model of motorcycle for which the stand is purchased so that when H-bracket is engaged the rear suspension of the motorcycle is raised only slightly allowing the rear wheel remains in contact with the ground to stabilize the motorcycle.

3. A motorcycle stand as described in claim 1 wherein the means to engage the motorcycle stand while the user is sitting on the motorcycle is comprised of a foot lever receiving a downward force that causes the motorcycle stand to rotate underneath the motorcycle that in turn imposes a force upward on the rear end of the motorcycle to engage the center stand.

4. A motorcycle stand as described in claim 1 wherein the means to lock the motorcycle stand in a vertical or parking position to prevent theft of the motorcycle is comprised of causing a padlock, a push pin type lock, a remotely operated electrical solenoid type lock, or a mechanical bolt operated by a mechanical or electrical means to be inserted through the lock aperture.

5. A motorcycle stand as described in claim 1 wherein the means to disengaged the motorcycle from the parking or vertical position and place in a horizontal or riding position by driving away on the motorcycle is comprised of powering the motorcycle in the forward direction and driving off of the center stand with one or two passengers using the power of the motor to rotate the motorcycle stand from the vertical or parking position to the horizontal or driving position.

6. A motorcycle stand comprised of
a frame bracket assembly,
an H-bracket assembly wherein the frame bracket assembly and the H-bracket assembly are connected via a common axel that is inserted through bushings on the frame bracket assembly where the H-bracket assembly is in a horizontal position while the motorcycle is being driven and a vertical position while the motorcycle is parked;
a means to lock the H-bracket assembly in the vertical position to prevent theft of the motorcycle;
wherein the H-bracket assembly is comprised of horizontal and vertical supports wherein the lengths of the vertical supports are closely fitted to the model of motorcycle for which the stand is used so that when the H-bracket is engaged the rear suspension of the motorcycle is raised only slightly to stabilize the motorcycle on the feet of the stand and the rear wheel remains in contact with the ground; and
wherein the H-bracket can be deployed by a motorcycle operator while still seated on the motorcycle without having to dismount the motorcycle first.
wherein the H-bracket assembly is disengaged and placed in the horizontal or riding position automatically when the motorcycle is driven or pushed forward.

7. The motorcycle stand described in claim 6 wherein
a spring engagement means normally keeps the H-bracket assembly in the horizontal position while the motorcycle is being ridden.

8. The motorcycle stand described in claim 6 wherein
the frame bracket assembly is comprised of a motorcycle frame bracket, a plurality of threaded square washers, and a plurality of bolts for mounting the frame bracket of the stand to the motorcycle frame.

9. The motorcycle stand described in claim 6 wherein
the H-bracket assembly is comprised of a pair of feet, a pair of vertical supports, a horizontal support, two H-bracket bushings, and a foot lever.

10. The motorcycle stand described in claim 6 wherein
the components of the H-bracket assembly arranged to form an essentially H shaped structure that supports the weight of the motorcycle when an embodiment is in the vertical position for parking the motorcycle while maintaining enough traction for the motorcycle to be driven off of the stand.

11. The motorcycle stand described in claim 6 wherein
when the motorcycle stand is in the horizontal or riding position the H-bracket assembly folds upward against the frame of the motorcycle where the H-bracket assembly is engaged to the frame bracket assembly through a means of an axel which is inserted through both the H-bracket bushings on the H-bracket assembly and through the two frame bracket assembly bushings affixed to the frame bracket assembly.

12. The motorcycle stand described in claim 6 wherein
the spring engagement means hold the H-bracket assembly in the normally horizontal or riding position.

13. The motorcycle stand described in claim 12 wherein
the spring engagement means are cylindrical torsion springs which hold the H-bracket part of the stand in the upright position or horizontal position.

14. The motorcycle stand described in claim 6 wherein the locking means can be provided by a simple padlock a push pin type lock, a remotely operated electrical solenoid type lock or a mechanical bolt operated by a mechanical or electrical means.

15. A method of using a motorcycle stand to park a motorcycle while the operator is still seated on the motorcycle comprising the steps of
pushing downward on a foot lever, which extends out from under the motorcycle far enough for access;
pressing a foot lever causes an H-bracket to swing through an arc from the horizontal position to fifteen degrees past the vertical position;
engaging the ground with the H-bracket thereby raising the rear suspension of the motorcycle slightly allowing the rear wheel to maintain contact with the ground.

16. A method of using a motorcycle stand to park a motorcycle while the operator is still seated on the motorcycle described in claim 15 comprising
disengaging the ground when the operator wishes to use the motorcycle by driving the motorcycle forward under the power of the motorcycle thereby returning the H-bracket assembly to the horizontal position automatically.
